(19) United States
(12) Patent Application Publication
(10) Pub. No.: US 2015/0268495 A1
(43) Pub. Date: Sep. 24, 2015

(54) LIQUID CRYSTAL OPTICAL ELEMENT AND IMAGE DEVICE

(71) Applicant: KABUSHIKI KAISHA TOSHIBA, Tokyo (JP)

(72) Inventors: Yukio KIZAKI, Kawasaki (JP); Yuko Kizu, Yokohama (JP); Honam Kwon, Kawasaki (JP); Machiko Ito, Yokohama (JP); Hideyuki Funaki, Tokyo (JP)

(21) Appl. No.: 14/660,245

(22) Filed: Mar. 17, 2015

(30) Foreign Application Priority Data
Mar. 18, 2014 (JP) 2014-054535

(51) Int. Cl. G02F 1/1337

(52) U.S. Cl. CPC G02F 1/1337; G02F 1/133784; G02F 1/133788; G02F 1/133723; G02F 2001/133749; G02F 2001/133738

(57) ABSTRACT

In a liquid crystal optical element, a first substrate includes a first main surface. A second substrate includes a second main surface opposed to the first main surface. First electrodes are provided on the first main surface. Common electrodes are provided on the second main surface. A liquid crystal layer is formed between the first main surface and the second main surface. A first alignment layer is formed between the first substrate and the liquid crystal layer. A second alignment layer is formed between the second substrate and the liquid crystal layer. The first alignment layer has an anchoring force that is weaker than an anchoring force of the second alignment layer.

### CROSS-REFERENCE TO RELATED APPLICATIONS

This application is based upon and claims the benefit of priority from Japanese Patent Application No. 2014-054535, filed Mar. 18, 2014, the entire contents of which are incorporated herein by reference.

### FIELD

Embodiments described herein relate to a liquid crystal optical element and an image device including the same.

### BACKGROUND

As technologies capable of measuring a distance to a subject in its depth direction, for example, a technology using reference light and a distance-measuring technology using a plurality of cameras are known. Recently in particular, the need for imaging devices capable of obtaining distance information with a relatively inexpensive configuration has increased for a new input device in consumer use.

A compound-eye imaging device is proposed as a multiple imaging device which allows a multiple parallax and suppresses a decrease in resolution. The imaging device includes a main lens unit and a multiple optical system as a reimaging optical system between the main lens unit and image sensor. As the multiple optical system, for example, a microlens array with a number of microlenses formed on the plane is used. Each light-emitting side of the microlenses faces a plurality of pixels to capture an image corresponding to light rays emitted from the microlens. The image formed by the imaging lens (main lens unit) is reimaged on a corresponding one of the pixels by the microlens. The eyepoint of the reimaged image is shifted by a parallax according to the location of the microlens. If a group of parallax images obtained from the microlenses is processed, a distance to a subject can be estimated by the principle of triangulation. If the parallax images are pieced together, they can be reconstructed as a two-dimensional image.

In general, the resolution of the two-dimensional image is lower than that of a two-dimensional image obtained in a state excluding the multiple optical system. The imaging device disclosed in Jpn. Pat. Appln. KOKAI Publication No. 2008-167395 is so configured that the presence or absence of a multiple optical system can be selected, thus making it possible to switch an imaging mode capable of measuring a distance to a subject in its depth direction and an imaging mode to capture a high-resolution two-dimensional image. In the imaging device of Jpn. Pat. Appln. KOKAI Publication No. 2008-167395, a liquid crystal optical element is set in an imaging state or a non-imaging state according to whether a voltage is applied or not in the liquid crystal optical element that is a combination of a liquid crystal lens element and a polarization-switching liquid crystal element as a multiple optical system.

Liquid crystal optical elements are known in which an imaging state or a non-imaging state is selected by controlling application of a voltage to a liquid crystal layer formed between an electrode curved like a lens and a flat electrode. In the liquid crystal optical elements, the interface of the liquid crystal layer becomes curved and accordingly it is difficult to achieve complete transparency in the non-imaging state. In contrast, a liquid crystal optical element using a gradient index (GRIN) lens has been proposed in which an imaging state or a non-imaging state is selected by varying the refractive index profile of a liquid crystal layer by controlling a voltage to the liquid crystal layer. If a GRIN lens is used, the interface of the liquid crystal layer does not become curved and accordingly transparency in the non-imaging state is improved. On the other hand, the optical characteristics in the imaging state of the GRIN lens should further be improved.

### BRIEF DESCRIPTION OF THE DRAWINGS

FIG. 1 is a diagram showing an example of a liquid crystal optical element according to a first embodiment;

FIG. 2 is a sectional view taken along line A-A of FIG. 1;

FIG. 3 is a sectional view taken along line B-B of FIG. 2;

FIG. 4 is a diagram showing a first electrode and a second electrode;

FIGS. 5A and 5B are diagrams each showing an arrangement of liquid crystal molecules corresponding to the state of applying a voltage;

FIGS. 6A and 6B are sectional views each showing an operation of the liquid crystal optical element;

FIG. 7 is a graph showing a refractive index profile of one lens unit of a liquid crystal optical element fabricated by each of the methods of example 1 and comparative example 1;

FIG. 8 is a graph showing a refractive index profile of one lens unit of a liquid crystal optical element fabricated by each of the methods of example 2 and comparative example 2;

FIG. 9 is a sectional view showing a configuration of a liquid crystal optical element according to a second embodiment;

FIG. 10 is a diagram illustrating a profile of lines of electric force and that of refractive indices in a liquid crystal optical element as a reference example in which a second electrode is symmetrical with respect to the central axis;

FIG. 11 is a diagram illustrating a profile of lines of electric force and that of refractive indices in the liquid crystal optical element in which a second electrode is asymmetrical with respect to the central axis;

FIG. 12 is a graph illustrating a refractive index profile in each of the liquid crystal optical elements;

FIG. 13 is a sectional view showing a configuration of a liquid crystal optical element according to a modification to the second embodiment;

FIG. 14 is a diagram illustrating a profile of lines of electric force and that of refractive indices in the liquid crystal optical element shown as a reference example in FIG. 10, in which a voltage applied to a first electrode is high;

FIG. 15 is a diagram illustrating a profile of lines of electric force and that of refractive indices in the liquid crystal optical element according to the modification;

FIG. 16 is a graph showing characteristics of the liquid crystal optical element according to the modification;

FIG. 17 is a schematic view showing a configuration of an imaging device as a first application example of a liquid crystal optical element; and

FIG. 18 is a schematic view showing a configuration of a display device as a second application example of a liquid crystal optical element.

### DETAILED DESCRIPTION

Embodiments will be described with reference to the accompanying drawings. The drawings are schematic or conceptual. The relationship between the thickness and width of each of the components or the size ratio of components in the drawings is not necessarily the same as those used in actual practice. The components shown in the drawings may be different in dimensions or ratio from actual ones.

### First Embodiment

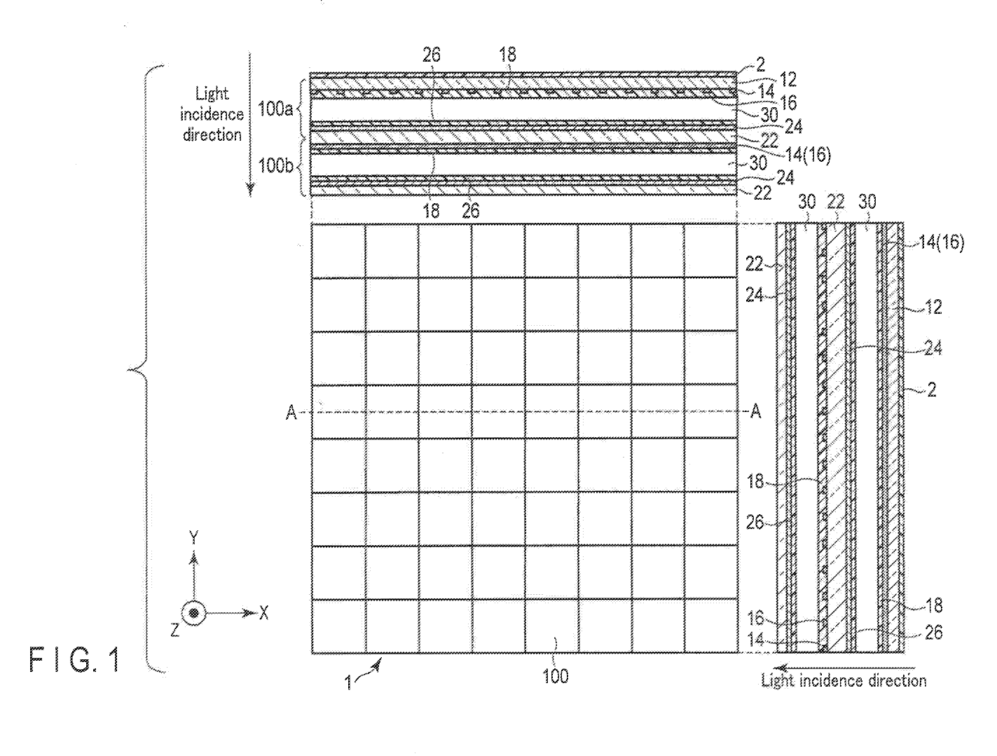

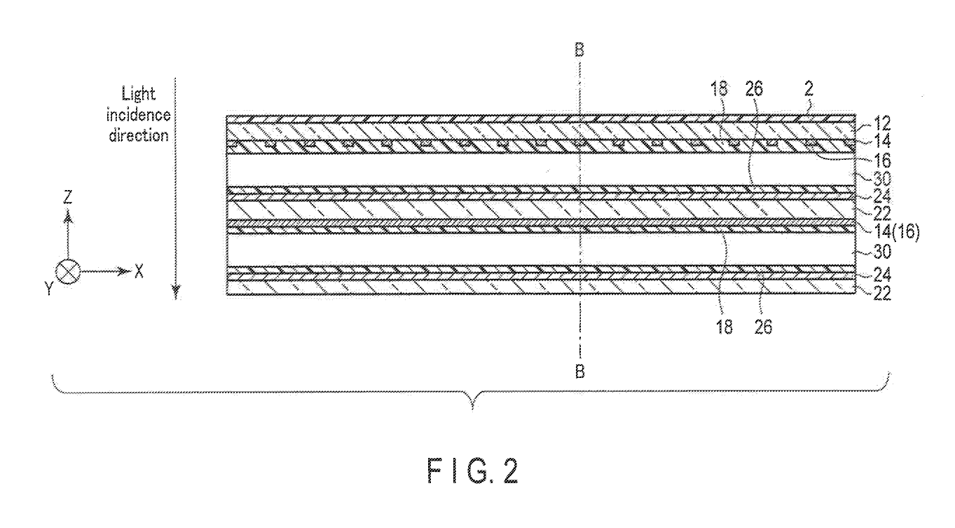

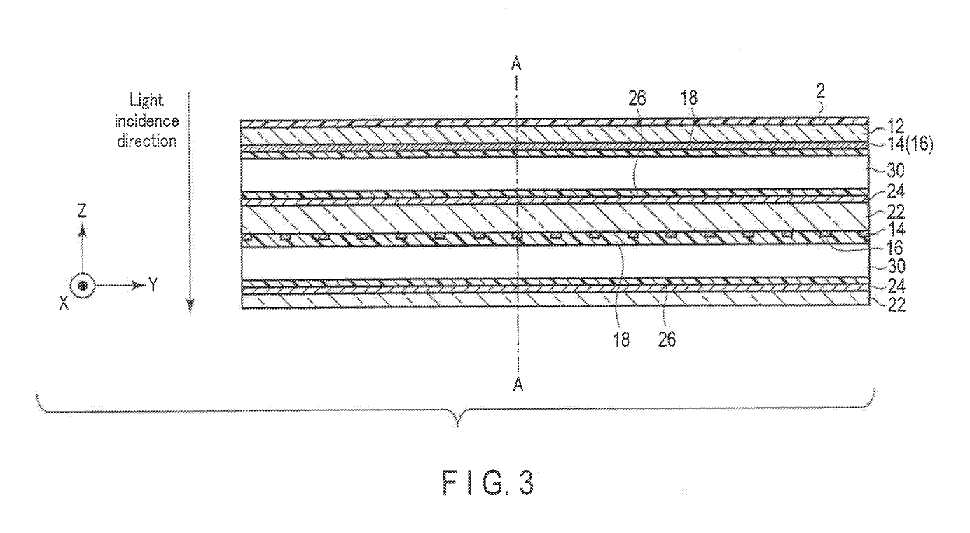

FIG. 1 is a diagram showing a specific example of a liquid crystal optical element according to a first embodiment. FIG. 2 is a sectional view taken along line A-A of FIG. 1. FIG. 3 is a sectional view taken along line B-B of FIG. 2. The sectional view of FIG. 2 is also one taken along line A-A of FIG. 3.

FIG. 1 shows a liquid crystal element 1 including a microlens array 100 including two-layered lens units 100a and 100b which are orthogonally arrayed. The lens unit 100a is formed and then the lens unit 100b is formed thereon when viewed from the incident direction of light. A polarizer 2 is formed on the light incident plane of the lens unit 100a. The lens units 100a and 100b have the same configuration, except for the direction of bonding to each other. Accordingly, the configuration of the lens unit 100a will be described, and the descriptions of the configuration of the lens unit 100b will be omitted.

The lens unit 100a includes a first substrate 12, first electrodes 14, a first alignment layer 18, a second substrate 22, common electrodes 24 and a second alignment layer 26. The lens unit 100a also includes a liquid crystal layer 30 between the first and second substrates 12 and 22. The second substrate 22 may be a half wave plate.

The first substrate 12 has a first main surface, and the second substrate 22 has a second main surface. The first and second main surfaces are opposed to each other.

The first electrodes 14 are provided on part of the first main surface. The common electrodes 24 are provided on part of the second main surface. The first electrodes 14 are opposed to some of the common electrodes 24.

The liquid crystal layer 30 is formed between the first and second main surfaces.

The first alignment layer 18 is formed between the first substrate 12 and the liquid crystal layer 30 to align the liquid crystal molecules of the liquid crystal layer 30 horizontally. The second alignment layer 26 is formed between the second substrate 22 and the liquid crystal layer 30 to align the liquid crystal molecules of the liquid crystal layer 30 horizontally. The anchoring force of the first alignment layer 18 is weaker than that of the second alignment layer 26.

In the first embodiment, second electrodes 16 are provided on the main surface of the first substrate 12 of the liquid crystal optical element 1. Each of the second electrodes 16 is provided between two adjacent first electrodes 14. The second electrodes 16 improve the characteristics of the refractive index profile in the liquid crystal layer 30.

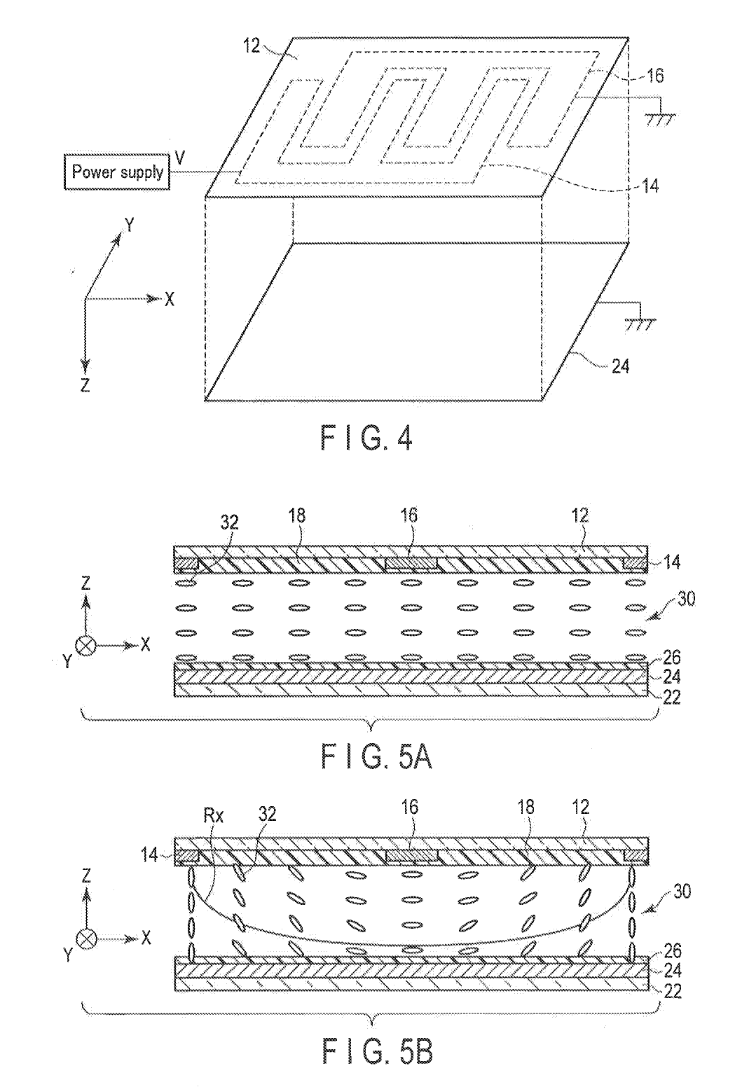

The first substrate 12 is flat and has optical transparency. As the first substrate 12, for example, quartz is used. The first substrate 12 has a main surface on which the first and second electrodes 14 and 16 are formed. In FIGS. 2 and 3, the first substrate 12 is shown such that the main surface corresponds to the XY surface, and the Z-axis direction is set parallel to the direction of light incident upon the liquid crystal optical element 1. The first and second electrodes 14 and 16 are made of optical transparency electrode materials, such as indium tin oxide (ITO) and extend linearly in the Y-axis direction. A predetermined voltage V is applied to the first electrodes 14 which are located at their corresponding edge portions of the microlenses. The first electrodes 14 are arranged at regular intervals. The second electrodes 16 are grounded, and each of the second electrodes is provided between two adjacent first electrodes 14 and located at a central position of a corresponding one of the microlenses. The second electrodes 16 are also arranged at regular intervals. FIG. 4 illustrates the first and second electrodes 14 and 16. As illustrated in FIG. 4, the first and second electrodes 14 and 16 are formed as, for example, comb-shaped electrodes and arranged alternately in the X-axis direction. The first and second electrodes 14 and 16 do not always need to be formed as comb-shaped electrodes.

The first alignment layer 18 is formed on the main surface of the first substrate 12, and initially provides a horizontal alignment of the liquid crystal molecules (especially near the main surface of the first substrate 12) in the liquid crystal layer 30. The anchoring force (anchoring energy) of the first alignment layer 18 is set weaker than that of the second alignment layer 26, which will be described later, i.e., the surface energy of the first alignment layer 18 is set smaller than that of the second alignment layer 26. To make an ordering relationship in the anchoring forces between the first and second alignment layers, for example, a horizontal photo-aligned layer is used as the first alignment layer 18. The horizontal photo-aligned layer is formed by irradiating polarized ultra-violet (UV) light to photoisomerization materials such as azobenzene and by aligning them in one direction. With the horizontal photo-aligned layer, the liquid crystal molecules are initially aligned in a direction parallel or perpendicular to the irradiation direction of the UV light. The polarized UV light is irradiated vertically or obliquely to the surface of the photoreactive materials. In both cases, the pretilt angle becomes almost 0°, as characteristics of the horizontal photo-aligned layer. The anchoring force (anchoring energy) of the liquid crystal molecules due to the horizontal photo-aligned layer depends upon the amount of irradiation light in photopolymerization. By controlling the amount of irradiation light, it is possible to form a horizontal photo-aligned layer whose anchoring force is very weak. The horizontal photo-aligned layer can be formed by photo-coupling materials and photodegradation-reaction materials as well as photoisomerization materials. As the photo-coupling materials, for example, polyimide having a photosensitive group, such as a 4-chalconyl group, a 4′-chalconyl group, a coumarin group and a cinnamoyl group can be used. As the photodegradation-reaction materials, for example, RN722, RN783 and RN784, which are provided by Nissan Chemical Industries, Ltd., or JALS-204, which is provided by JSR Corporation, can be used.

The second substrate 22 is flat and has optical transparency. As the second substrate 22, for example, quartz is used. The second substrate 22 has a main surface which is, for example, parallel and opposite to the main surface of the first substrate 12. In the embodiment shown in FIGS. 1-3, the second substrate 22 also serves as a first substrate in the lens unit 100b. Naturally, another first substrate can be provided for the lens unit 100b. The second substrate 22 in this position may be a half wave plate to rotate optical axes of the incident light. The common electrodes 24 are made of electrode materials having optical transparency, such as indium tin oxide (ITO), and they are planar electrodes formed on the main surface of the second substrate 22. As illustrated in FIG. 4, the common electrodes 24 are grounded. In the first embodiment, the common electrodes 24 are formed over the whole surface of the substrate; however, this is not limitative. For example, the common electrodes 24 can be partially provided on a region opposite to the first and second electrodes 14 and 26.

The second alignment layer 26 is formed on the main surface of the second substrate 22 and initially provides a horizontal alignment of the liquid crystal molecules (especially near the main surface of the second substrate 22) in the liquid crystal layer 30. To make the foregoing relationship in anchoring force, for example, a horizontal aligned layer by rubbing is used as the second alignment layer 26. The horizontal alignment layer by rubbing 26 is formed by rubbing the surface (e.g., the surface of polyimide) and has a surface anisotropy in which liquid crystal molecules can be aligned along the direction of rubbing. The anchoring force (anchoring energy) of the liquid crystal molecules can be controlled under conditions such as a rotational speed of a rubbing roller and pressure of the rubbing roller on the substrates. The pretilt angle of liquid crystal molecules generated on an interface between the alignment layer and the liquid crystal layer typically becomes about 1° to 3°. By controlling the foregoing conditions it is possible to form a horizontal alignment layer whose anchoring force is weak (but stronger than that in the first alignment layer) so as to increase the amount of optical modulation by driving the device.

The liquid crystal layer 30 is formed between the first and second substrates 12 and 22 and its refractive index profile is varied with application of a voltage. As the liquid crystal layer 30, for example, nematic liquid crystal is used. Hereinafter, it is assumed that nematic liquid crystal having a positive dielectric anisotropy is used as the liquid crystal layer 30. The liquid crystal layer 30 may have a negative dielectric anisotropy or a liquid crystal other than nematic liquid crystal can be used.

The first and second electrodes 14 and 16 of the lens unit 100a are arranged in the X-axis direction. The first and second electrodes 14 and 16 of the lens unit 100b are arranged in the Y-axis direction.

The polarizer 2 is provided opposite the liquid crystal layer 30 with the first substrate 12 of the lens unit 100a between them. The polarizer 2 polarizes incident light into light having a transmission axis in the vertical and horizontal directions (or an oblique direction between them) and makes the polarized light incident upon the liquid crystal layer 30. The polarizer 2 can be composed of a linear polarized plate having an optical axis in the direction (X-axis direction) in which the first and second electrodes 14 and 16 are arranged. The polarizer 2 can be composed of a circularly polarized plate.

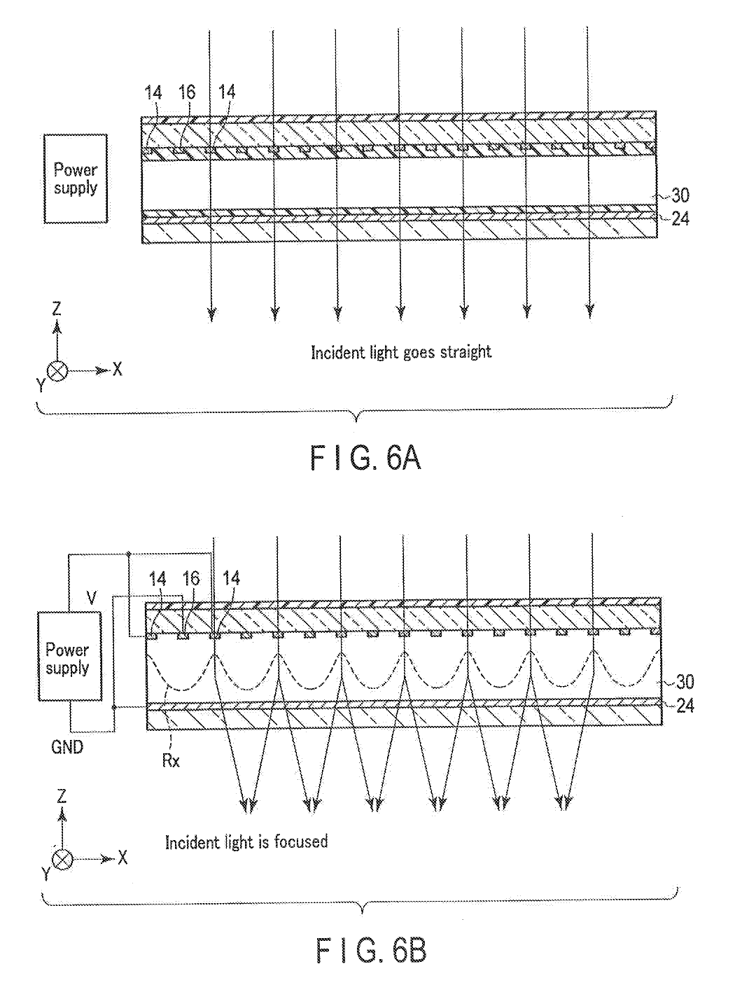

Below are descriptions of an operation of the liquid crystal optical element 1. FIGS. 5A and 5B are diagrams each showing an arrangement of liquid crystal molecules corresponding to the application state of a voltage. FIGS. 6A and 6B are sectional views each showing an operation of the liquid crystal optical element 1. FIGS. 5A, 5B show one of the lens units.

When no voltage is applied, liquid crystal molecules 32 in the liquid crystal layer 30 are oriented uniformly in the horizontal direction with respect to the XY plane under the anchoring force from the horizontal alignment layer, as shown in FIG. 5A. The direction of the orientation of the liquid crystal molecules 32 projected on the XY plane is, for example, a direction (X-axis direction) in which the first electrodes 14 are arranged. The direction of the orientation of the liquid crystal molecules 32 is, for example, vertical direction (Z-axis direction). In this case the direction of projection is not unique. As the orientation of the liquid crystal molecules 32 in the liquid crystal layer 30 is uniform, the refractive index in the liquid crystal layer 30 is uniform within the plane. Accordingly, the incident light goes straight as shown in FIG. 6A. The liquid crystal optical element 1 is thus brought into a non-lens state.

On the other hand, voltage V is applied to the first electrodes 14, and the common electrodes 24 are connected to the GND. If the second electrodes 16 are provided, they are connected to the GND. In this case, as shown in FIG. 5B, the liquid crystal molecules 32 in the liquid crystal layer 30 are re-oriented according to the electric field distribution formed in the liquid crystal layer 30. Accordingly, as shown in FIG. 6B, a refractive index profile Rx is exhibited in the liquid crystal layer 30. As shown in FIG. 6B, the refractive index periodically varies along the arrangement direction (X-axis direction) of the first electrodes 14. At this time, the liquid crystal layer 30 serves as a gradient index (GRIN) lens to focus light as shown in FIG. 6B. Thus, the liquid crystal optical element 1 is brought into a lens state.

As described above, the liquid crystal optical element 1 can be switched to a lens state or a non-lens state according to whether a voltage is applied or not. In the examples shown in FIGS. 6A and 6B, the dielectric anisotropy of the liquid crystal layer 30 is positive. If the dielectric anisotropy of the liquid crystal layer 30 is negative, the refractive index profile is shifted by half a period along the arrangement direction (X-axis direction) of the first electrodes 14 with respect to the profile shown in FIG. 6B.

As described above, the lens units 100a and 100b are bonded together such that the first electrodes 14 of the lens unit 100a and those of the lens unit 100b are substantially orthogonal. Accordingly, the direction of the periodical refractive index profile in the lens unit 100a and that in the lens unit 100b are substantially orthogonal to each other. Thus, the light is focused in the X-axis direction in the lens unit 100a and is focused in the Y-axis direction in the lens unit 100b. Therefore, the lens units 100a and 100b as a whole serve as a microlens array. In contrast, when the lens unit is used alone, they serve as a cylindrical lens.

The direction in which the cylindrical lens of the lens unit 100a extends is substantially orthogonal to the direction in which the cylindrical lens of the lens unit 100b extends.

In the examples shown in FIGS. 1-3, the direction in which the refractive index profile is exhibited in the lens unit 100a and that in the lens unit 100b are substantially orthogonal to each other. The direction of polarization axis in which light focusing effect becomes a maximum should be orthogonal between the lens unit 100a through which light passes first and the lens unit 100b. If the liquid crystal layer 30 of the lens unit 100a is twisted, the polarization axis plane of incident light rotates in the liquid crystal layer 30, with the result that the direction of polarization axis for light emitted from the lens unit 100a becomes coincident with the direction of polarization axis in which the light focusing effect becomes a maximum in the lens unit 100b. For example, the alignment direction of the first alignment layer 18 in the lens unit 100a and that of the second alignment layer 26 therein can be set orthogonal to each other.

In the first embodiment, horizontal alignment layers on the first and second substrates are so formed that the anchoring force on the first substrate side is weaker than that on the second substrate side. This makes it possible to improve the optical characteristics of the liquid crystal element. In the first embodiment, the horizontal alignment layer formed on the first substrate is a horizontal photo-aligned layer and the horizontal alignment layer formed on the second substrate is a aligned layer by rubbing. The anchoring force on the first substrate side has only to be weaker than that on the second substrate side, and the horizontal alignment layer formed on the first substrate is not always a horizontal photo-aligned layer. For example, it can be formed as an aligned layer by rubbing.

### Example 1

Example 1 according to the foregoing first embodiment will be described. Following example 1 is an example for one of the lens unit 100a and 100b. First, Comb-shaped electrodes each of which has an electrode width of 10 μm and an interval between which is 115 μm were formed of ITO on the surface of a single glass substrate (whose thickness is 0.7 mm) by a conventional method. Then, RN-1338 (manufactured by Nissan Chemical Industries, Ltd.), which is a polyimide material, was cast on the surfaces of the electrodes to have a thickness of 100 nm by means of a spin coater. The electrodes were irradiated with linearly polarized light whose wavelength is 365 nm at an irradiation light intensity of about 0.2 J/cm2 to form a horizontal alignment layer having an anchoring direction in the direction perpendicular to the direction of the linearly polarized light. After that, the resultant structure was baked at 230° C. for 20 to 30 minutes to obtain a first substrate. On the other hand, ITO electrode was formed on the entire surface of another glass substrate (whose thickness is 0.7 mm) by a conventional method. SE-7497 (manufactured by Nissan Chemical Industries, Ltd.), for an alignment layer, was cast on the surfaces of the electrodes to have a thickness of 100 nm by means of a spin coater, and the resultant structure was baked at 230° C. for 20 to 30 minutes. After that, a rubbing alignment process was performed to form a horizontal alignment layer having an anchoring direction in the direction parallel to the rubbing direction, thus obtaining a second substrate.

Adhesive for bonding was applied to a given position on the surface of the second substrate obtained as described above. The adhesive contains 1% spacers with a diameter of 10 μm. Spacers with a diameter of 10 μm were also scattered on the surface of the first substrate to secure a uniform cell gap. After that, the first and second substrates were bonded and sealed such that the alignment layers were opposed to each other and the anchoring directions became parallel, thus obtaining liquid crystal cells. Nematic liquid crystal, BL035 (manufactured by Merck Co., Ltd.) was injected into the liquid crystal cells by a conventional method. Then, polarizers were provided with the first and second substrates, respectively for use in an evaluation. These polarizers were so provided that they had an angle of 45° between the alignment direction and the transmission axis and that their transmission axes were perpendicular to each other. A liquid crystal optical element 1 was fabricated by connecting a power supply to the liquid crystal cells.

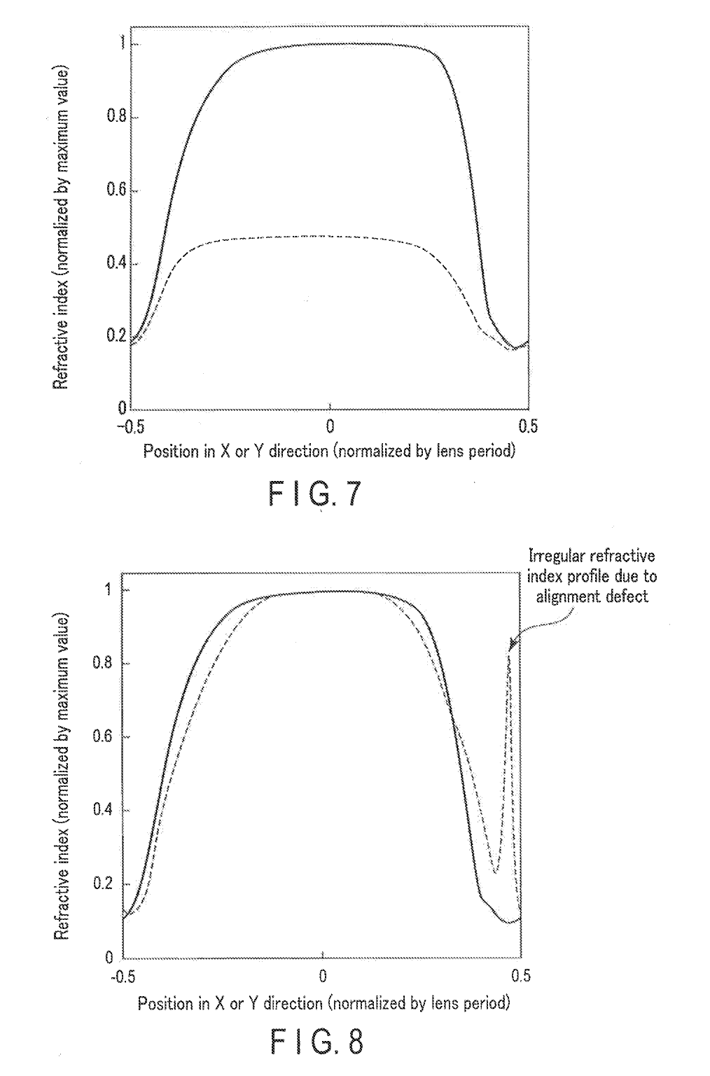

In FIG. 7, the solid line indicates a refractive index profile of one lens unit of the liquid crystal optical element 1 in PA mode (i.e. horizontal alignment), which was fabricated by the method according to example 1. In the refractive index profile indicated by the solid line in FIG. 7, the applied voltage is 2 V. As shown in FIG. 7, the liquid crystal optical element 1 according to example 1 has a large amount of variation in refractive index and satisfactory light focusing characteristics.

### Comparative Example 1

Comparative example 1 corresponding to example 1 will be described. In comparative example 1, a liquid crystal optical element 1 was fabricated under the same conditions as that in example 1, except for the formation of alignment layers. First, Comb-shaped electrodes of ITO were formed on the surface of a single glass substrate by a conventional method. Then, AL-60805 (manufactured by JSR Corporation), for an alignment layer, was cast on the surfaces of the electrodes to have a thickness of 100 nm by means of a spin coater, and the resultant structure was baked at 230° C. for 20 to 30 minutes. After that, a rubbing alignment process is performed to form a vertical alignment layer and obtain a first substrate. On the other hand, ITO electrodes were formed on the entire surface of another glass substrate (whose thickness is 0.7 mm) by a conventional method. AL-1254 (manufactured by JSR Corporation), for an alignment layer, was cast on the surfaces of the electrodes to have a thickness of 100 nm by means of a spin coater, and the resultant structure was baked at 230° C. for 20 to 30 minutes. After that, a rubbing alignment process is performed to form a horizontal alignment layer having an anchoring direction in a direction parallel to the rubbing direction and then obtain a second substrate.

In FIG. 7, the broken line indicates a refractive index profile of one lens unit of a liquid crystal optical element 1 in HAN (hybrid-aligned nematic) mode, which was fabricated by the method according to comparative example 1. In the refractive index profile indicated by the broken line in FIG. 7, the applied voltage is 2 V. Comparing two optical elements having few alignment defects (disclinations), it is found that the variation of refractive index in the case of a vertical alignment layer is smaller than that in the case where of a horizontal alignment layer (having a weak anchoring force) on the first substrate.

### Example 2

Example 2 according to the foregoing embodiment will be described. First, Comb-shaped electrodes each of which has an electrode width of 30 μm and an interval between which is 230 μm were formed of ITO on the surface of a single glass substrate (whose thickness is 0.7 mm) by a conventional method. Then, RN-1338 (manufactured by Nissan Chemical Industries, Ltd.), which is a polyimide material, was cast on the surfaces of the electrodes to have a thickness of 100 nm by means of a spin coater, and the electrodes were irradiated with linearly polarized light whose wavelength is 365 nm at an irradiation light intensity of about 0.2 J/cm2 to form a horizontal alignment layer having an anchoring direction in the direction perpendicular to the direction of the linearly polarized light. After that, the resultant structure was baked at 230° C. for 20 to 30 minutes to obtain a first substrate. On the other hand, ITO electrodes were formed on the entire surface of another glass substrate (whose thickness is 0.7 mm) by a conventional method. SE-7497 (manufactured by Nissan Chemical Industries, Ltd.), for an alignment layer, was cast on the surfaces of the electrodes to have a thickness of 100 nm by means of a spin coater, and the resultant structure was baked at 230° C. for 20 to 30 minutes. After that, a rubbing alignment process was performed to form a horizontal alignment layer having an anchoring direction in the direction parallel to the rubbing direction and accordingly a second substrate was obtained.

Adhesive for bonding (containing 1% spacers with a diameter of 40 μm) was applied to a given position on the second substrate obtained by the above-described method. Spacers with a diameter of 40 μm were also scattered on the surface of the first substrate to secure a uniform cell gap. After that, the first and second substrates were bonded and sealed such that the alignment layers were opposed to each other and the anchoring directions became the same, thus obtaining liquid crystal cells. Nematic liquid crystal, BL035 (manufactured by Merck Co., Ltd.) was injected into the liquid crystal cells by a conventional method. Then, polarizers for an evaluation were bonded on outsides of the elements with an angle of 45° between the alignment direction and the transmission axis of the polarizers and with their transmission axes perpendicular to each other. With the result of connecting a power supply, a liquid crystal optical element 1 was fabricated.

In FIG. 8, the solid line indicates a refractive index profile of one lens unit of the liquid crystal optical element 1 in PA mode, which was fabricated by the method according to example 2 and whose anchoring force is very weak on the first substrate side. The applied voltage in the case of the refractive index profile indicated by the solid line in FIG. 8 is 1.8 V. As shown in FIG. 8, the liquid crystal optical element 1 according to example 2 decreases in driving voltage, and has satisfactory light focusing characteristics.

### Comparative Example 2

Comparative example 2 corresponding to example 2 will be described. In comparative example 2, a liquid crystal optical element 1 was fabricated under the same condition as that in example 2, except for the formation of alignment layers. First, Comb-shaped electrodes of ITO were formed on the surface of a single glass substrate by a conventional method. Then, AL-1254 (manufactured by JSR Corporation), for an alignment layer, was cast on the surfaces of the electrodes to have a thickness of 100 nm by means of a spin coater, and the resultant structure was baked at 230° C. for 20 to 30 minutes. After that, a rubbing alignment process is performed to form a horizontal alignment layer having an anchoring direction in the direction parallel to the rubbing direction and then obtain a first substrate. The same alignment layer as described above is formed on the surface of another glass substrate to obtain a second substrate.

In FIG. 8, the broken line indicates a refractive index profile of one lens unit of a liquid crystal optical element 1 in PA mode, which was fabricated by the method according to comparative example 2 and in which the first and second substrates have the same anchoring force. In the refractive index profile indicated by the broken line in FIG. 8, the applied voltage is 5 V. When an alignment layer having a strong anchoring force is formed on each of the first and second substrates, not only a driving voltage increases, but also domains are generated in which liquid crystal molecules rise in opposite directions when a voltage is applied. Thus, an irregular refractive index profile due to alignment defects (disclinations) was observed. In contrast, such an irregular profile was not found in the solid line in FIG. 8 corresponding to example 2.

The inventors made the same comparison by considering that the alignment layer formed on the first substrate and that formed on the second substrate are both photo-aligned layers. In this case, too, an irregular refractive index profile due to alignment defects was observed. It is found from this comparison that the alignment defects can be prevented by introducing a difference in anchoring force between the first and second substrates rather than by simply weakening the anchoring force.

### Second Embodiment

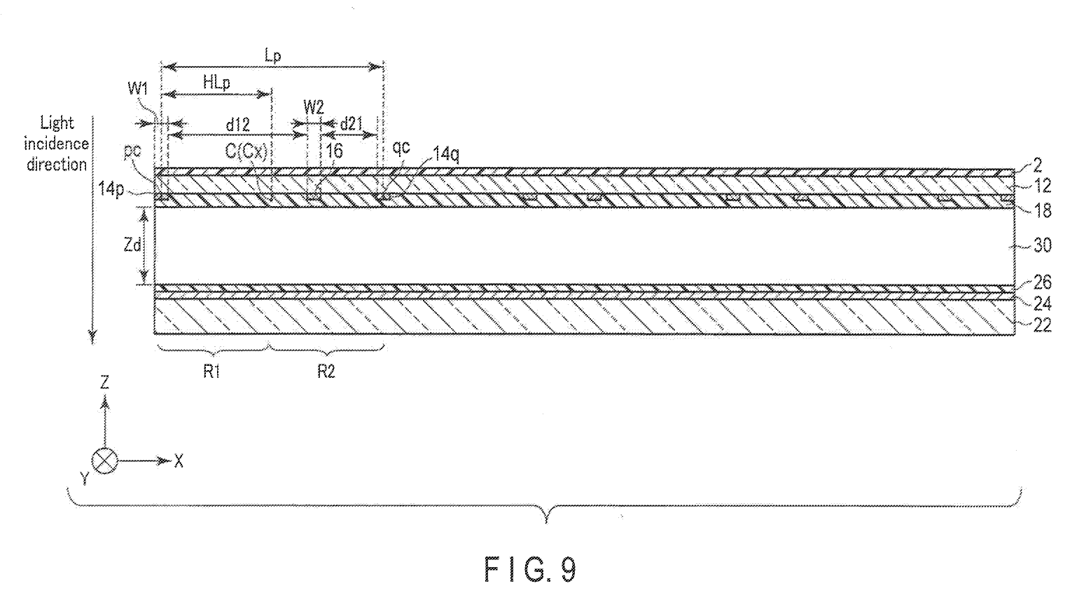

A second embodiment will be described below. FIG. 9 is a sectional view showing a configuration of a liquid crystal optical element according to the second embodiment. Hereinafter, the same elements as those of the first embodiment are denoted by the same reference numerals and their descriptions are omitted. In the first embodiment, the pretilt angle of liquid crystal molecules on the first substrate side is almost 0° and that of liquid crystal molecules on the second substrate side is approximately 1° to 3°. In the second embodiment, the pretilt angle of liquid crystal molecules is approximately not less than 0° and not greater than 300.

In the second embodiment, closest two first electrodes 14 and a second electrode 16 provided between them will be described in detail. Hereinafter, one (e.g., the left one) of the closest two first electrodes 14 is considered to be a first electrode 14p and the other (e.g., the right one) is considered to be a first electrode 14q. Assume that a central axis cx is located at the midpoint of the distance between the first electrodes 14p and 14q. The central axis cx passes through the midpoint c of a segment between the center pc of the first electrode 14p and the center qc of the first electrode 14q, and is parallel to the Y axis. Further, a region between a plane which is orthogonal to the main surface of a first substrate 12 and passes through the center pc of the first electrode 14p and a plane which is orthogonal to the main surface of the first substrate 12 and passes through the central axis cx is considered to be a first region R1. Furthermore, a region between a plane which is orthogonal to the main surface of the first substrate 12 and passes through the center qc of the first electrode 14q and a plane which is orthogonal to the main surface of the first substrate 12 and passes through the central axis cx is considered to be a second region R2. The first and second regions R1 and R2 are parallel to the first main surface of the first substrate 12.

In the second embodiment, the second electrode 16 is provided between the first electrodes 14p and 14q and is asymmetrical with respect to the central axis cx. In the example of FIG. 9, the second electrode 16 is provided in the second region R2 and not in the first region R1. The distance between the first electrode 14p and the second electrode 16 in the X-axis direction is considered to be a first distance d12. The distance between the second electrode 16 and the first electrode 14q in the X-axis direction is considered to be a second distance d21. Since the second electrode 16 is asymmetrical with respect to the central axis cx, the first and second distances d12 and d21 differ from each other. In the example of FIG. 9, the relationship in position between the first electrodes 14p and 14q and the second electrode 16 is given by the following formulae (1) to (3).

Lp=W1+d12+W2+d21 (1)

HLp=Lp/2 (2)

d12>d21 (3)

Lp is a distance (electrode pitch) in the x-axis direction between the center pc of the first electrode 14p and the center qc of the first electrode 14q. HLp is a distance between the center of one of the first electrodes (e.g., the first electrode 14p) and the midpoint c. W1 is a width of each of the first electrodes 14p and 14q in the X-axis direction. W2 is a width of the second electrode 16 in the X-axis direction. For example, the absolute value of a difference between the first and second distances d12 and d21 (Δd=|d12−d21|) can be set greater than at least one of the widths W1 and W2. In FIG. 9, the absolute value (Δd=|d12−d21|) is greater than each of the widths W1 and W2. In other words, the absolute value satisfies the relationship given by the following formulae (4) and (5).

|d12−d21|>W1 (4)

|d12−d21|>W2 (5)

Moreover, the thickness of a liquid crystal layer 30 is denoted by Zd. Zd is, for example, not less than 2 μm and not greater than 200 μm. Lp is, for example, not less than 10 μm and not greater than 600 μm. W1 is, for example, not less than 1 μm and not greater than 50 μm. W2 is, for example, not less than 1 μm and not greater than 500 μm. Δd=is, for example, not less than 0.5 times and not greater than 50 times as great as W1. Δd=is also, for example, not less than 0.5 times and not greater than 50 times as great as W2. Δd=is also, for example, not less than 2% and not greater than 95% of Lp.

Two or more second electrodes 16 can be provided between the first electrodes 14p and 14q and, in this case, either of the second electrodes 16 has only to be asymmetrical with respect to the central axis cx.

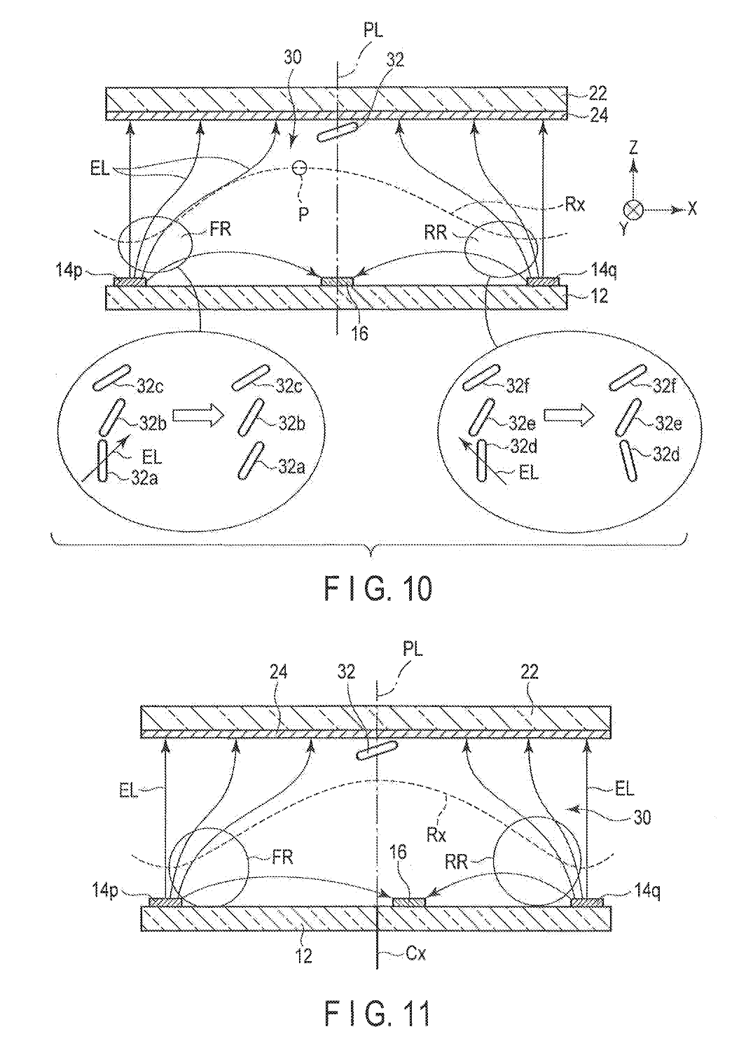

FIG. 10 is a diagram illustrating a profile of lines of electric force and that of refractive indices in a liquid crystal optical element according to a reference example in which the second electrode 16 is symmetrical with respect to the central axis cx. The illustration of alignment layers is omitted from FIG. 10. The diagram of FIG. 10 is presented as an inverted one of FIG. 9 for the sake of description.

In the liquid crystal optical element shown in FIG. 10, when a voltage V is applied to the first electrodes 14p and 14q and the second and common electrodes 16 and 24 are grounded, lines of electric force EL as shown in FIG. 10 are generated between the first electrodes 14p and 14q and the second and common electrodes 16 and 24. In general, when the dielectric anisotropy of the liquid crystal layer 30 is positive, the orientation of liquid crystal molecules 32 (the direction of the major axis of liquid crystal molecules 32) in a dense area of the lines of electric force EL (i.e., an area of strong electric field) varies according to the routes of the lines of electric force EL. For example, the liquid crystal molecules 32 in a portion where the first electrodes 14p and 14q are opposed to the common electrode 24 are oriented almost in the vertical direction. The density of the lines of electric force EL is low in a portion where the second electrode 16 is opposed to the common electrode 24. Thus, in the above potion, the liquid crystal molecules 32 are remained in the initial state, or in the horizontal direction. In a portion between the first and second electrodes 14 and 16, the orientation of the liquid crystal molecules 32 varies such that it approaches the vertical direction gradually from the second electrode 16 to the first electrodes 14p and 14q, with the result that a convex-lens-shaped refractive index profile Rx (a profile where refractive index is low in the portion above the first electrodes 14p and 14q and gradually increases toward the portion above the second electrode 16) as shown in FIG. 10 is exhibited in the liquid crystal layer 30.

In the liquid crystal optical element shown in FIG. 10, for example, the lines of electric force EL are distributed symmetrically in substance with respect to the central axis between the first electrodes 14p and 14q in the X-axis direction. However, the refractive index profile Rx is not symmetrical with respect to the central axis between the first electrodes 14p and 14q in the X-axis direction, because the relationship between the directions of inclination in the lines of electric force EL and the direction of pretilt for the liquid crystal molecules 32 are opposite with regard to the central axis cx as a boundary. In the example of FIG. 10, the direction of the lines of electric force EL in a region (forward direction region FR) close to the first electrode 14p is disposed in the same direction as the direction of pretilt for the liquid crystal molecules 32. In contrast, the direction of the lines of electric force EL in a region (reverse direction region RR) close to the first electrode 14q is disposed in the direction opposite to the direction of pretilt for the liquid crystal molecules 32.

The lower part of FIG. 10 shows orientational states of the liquid crystal molecules 32 in the forward and reverse direction regions FR and RR. In these part of FIG. 10, the left (of each arrow) shows that orientational state is a state where the lines of electric force EL have not yet operated upon the liquid crystal molecules, and the right shows that orientational state is a state where the lines of electric force EL have already operated upon the liquid crystal molecules.

In the forward direction region FR, the direction of inclination of a liquid crystal molecule 32a already influenced by a line of electric force EL which is the closest to the first electrode 14p and close to the right side of the first electrode 14p, is the same as the directions of inclination of liquid crystal molecules 32b and 32c disposed above the liquid crystal molecule 32a. In this case, a director (average long axes of liquid crystal molecules in a unit volume) is inclined in a region close to the right side of the first electrode 14p and its horizontal components are easily increased. Accordingly, the refractive index increases in the region close to the right side of the first electrode 14p. In the forward direction region FR, the liquid crystal molecules 32 rise along the lines of electric force EL extending in the vertical direction (Z-axis direction) in a region that is directly above the first electrode 14p and close to the second substrate 22. As a result, the horizontal components of the director reduce, and the refractive index in the region close to the second substrate 22 in the region directly above the first electrode 14p decreases. In the forward direction region FR, therefore, the variation of the refractive index in the region closest to the first electrode 14p and that in the region directly above the first electrode 14p and close to the second substrate 22 compensate for each other. Thus, the decrease in refractive index in a region which is on the right side of the center of the first electrode 14p and which is above and close to the first electrode 14p, is suppressed.

In the reverse direction region RR, the direction of inclination of a liquid crystal molecule 32d, already influenced by a line of electric force EL which is on the left side of the first electrode 14q, is opposite to the directions of inclination of liquid crystal molecules 32e and 32f disposed above the liquid crystal molecule 32d. In this case, the rotational torque of the liquid crystal molecule 32d and that of the liquid crystal molecule 32e compensate for each other. Accordingly, it is difficult for the liquid crystal molecule 32d that is on the left side of the first electrode 14q to be inclined. When the electric field is very strong, the liquid crystal molecule 32d closest to the first electrode 14q is inclined in a direction opposite to the liquid crystal molecules 32e and 32f disposed above the liquid crystal molecule 32d, with the result that deformation to a bend alignment is present. The middle of the bend alignment is a vertical alignment. In the region on the left side of first electrode 14q, vertical components of the director are likely to be maintained as the whole of the liquid crystal layer 30. In the reverse direction region RR, the liquid crystal molecules 32 rise along the lines of electric force EL extending in the vertical direction (Z-axis direction) in a region that is directly above the first electrode 14q and close to the second substrate 22. As a result, the horizontal components of the director are reduced, and the refractive index in the region close to the second substrate 22 in the region directly above the first electrode 14q decreases. Unlike in the forward direction region FR, in the reverse direction region RR, variation in the refractive index is small in the region close to the first electrode 14q, whereas the refractive index decreases in the region above the first electrode 14q. Therefore, in the reverse direction region RR the foregoing compensation effect is not produced as in the forward direction region FR, and the amount of decrease in refractive index becomes larger than that in the forward direction region FR.

As described above, in the configuration of the liquid crystal optical element of a reference example in which the second electrode 16 is disposed at the midpoint of the distance between the first electrodes 14, the profiles of variation (e.g., reduction) in refractive index are different between the forward and reverse direction regions FR and RR. As a result, the peak position of the refractive index does not match the position of the central axis cx between the first electrodes 14. In the example of FIG. 10, the peak position of the refractive index moves in the left direction from the central axis cx. Thus, the profile of refractive index Rx is asymmetric (asymmetric with respect to the plane PL passing through the central axis cx).

FIG. 11 is a diagram illustrating a profile of lines of electric force and that of refractive indices in the liquid crystal optical element according to the second embodiment, in which the second electrode 16 is asymmetrical with respect to the central axis cx. The second electrode 16 is provided at a position shifted right from the central axis cx. In the forward direction region FR, horizontal electric field components are decreased near the first electrode 14p and a reduction in the refractive index is enhanced. In the reverse direction region RR, the horizontal electric field components are increased near the first electrode 14q and a reduction in the refractive index is suppressed. As a result, a difference in the amount of reduction in the refractive index becomes small between the forward direction region FR and the reverse direction region RR. Therefore, the refractive index profile Rx becomes, symmetrical or nearly symmetrical.

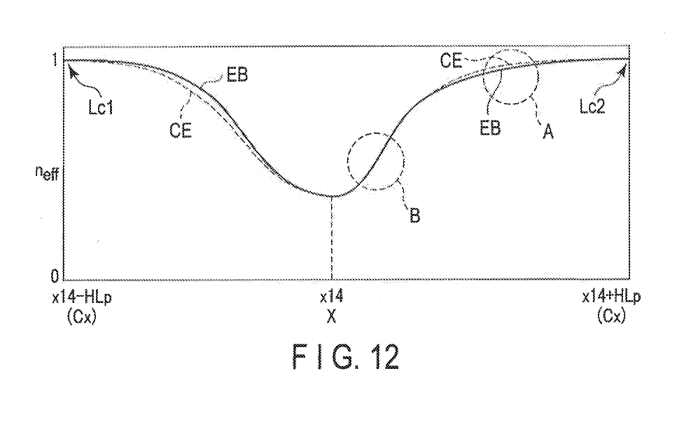

FIG. 12 is a graph illustrating a refractive index profile in each of the liquid crystal optical elements. In FIG. 12, the solid line EB indicates a refractive index profile of the liquid crystal optical element according to the second embodiment in which the second electrode 16 is asymmetrical with respect to the central axis cx, and the broken line CE indicates a refractive index profile of the liquid crystal optical element according to the reference example in which the second electrode 16 is symmetrical with respect to the central axis cx. In FIG. 12, the horizontal axis represents a position in the X-axis direction. A position X14 is an X position corresponding to the center of the first electrode 14 (first electrode 14p or 14q). A position X14-HLp or a position X14+HLp is a position corresponding to the central axis cx. The central axis cx substantially corresponds to the central position of a lens formed according to the refractive index profile Rx exhibited in the liquid crystal layer 30 (the position X14-HLp corresponds to the central position Lc1 of the left one of two microlenses arranged in the X direction, and the position X14+HLp corresponds to the central position Lc2 of the right one of the two microlenses). In FIG. 12, the vertical axis represents a refractive index neff of the liquid crystal layer 30. The refractive index neff is normalized by the values obtained when no voltage is applied.

In the refractive index profile CE shown in FIG. 12, the refractive index neff gradually lowers (monotonously reduces) toward the center of the first electrode 14 from the central position Lc1 (X14-HLp) of the left lens. Meanwhile, the reduction in refractive index neff is suppressed in an area (a portion indicated by A in FIG. 12) alongside the central position Lc2 of the right lens in the region between the center of the first electrode 14 and the central position Lc2. Further, the refractive index neff varies abruptly in an area (a portion indicated by B in FIG. 12) alongside the first electrode 14 in the region between the first electrode 14 and the central position Lc2 of the right lens.

On the other hand, in the refractive index profile EB shown in FIG. 12, the refractive index neff lowers more abruptly than in the refractive index profile CE between the central position Lc1 of the left lens and the center of the first electrode 14. The refractive index neff varies more gradually between the center of the first electrode 14 and the central position Lc2 of the right lens. In other words, the symmetry of the refractive index profile EB is higher than that of the refractive index profile CE in the second embodiment.

In the second embodiment as described above, the second electrode 16 is disposed at a position that is asymmetrical with respect to the central axis cx between adjacent two first electrodes 14, in addition to the configuration of the first embodiment. In this case, the liquid crystal molecules close to the second substrate 22 are aligned to the second substrate 22 toward the positive direction of the X axis (the direction from the first electrode 14p to the first electrode 14q). The direction of a tilt of a liquid crystal director in the center of the liquid crystal layer 30 is the same as the alignment direction of the liquid crystal molecules. The liquid crystal layer 30 as a whole includes an orientation in which the director tilts up toward the second substrate 22 along the positive direction of the X axis. If the first distance d12 is made longer than the second distance d21 at that time, the symmetry of the refractive index profile Rx can be improved.

The asymmetry of the refractive index profile of the liquid crystal layer 30 includes a shift in the bottom position in the refractive index profile Rx as well as a shift in the peak position therein. The amounts of shift in the bottom position are not always the same. Thus, even though the position of the second electrode 16 is shifted to improve the symmetry of the refractive index profile Rx as in the second embodiment, a difference in the period of the refractive index profile and that of electrode arrangement (lens pitch) may be shifted. It is thus favorable to use the liquid crystal optical element 1 taking the shift into account.

### Modification to Second Embodiment

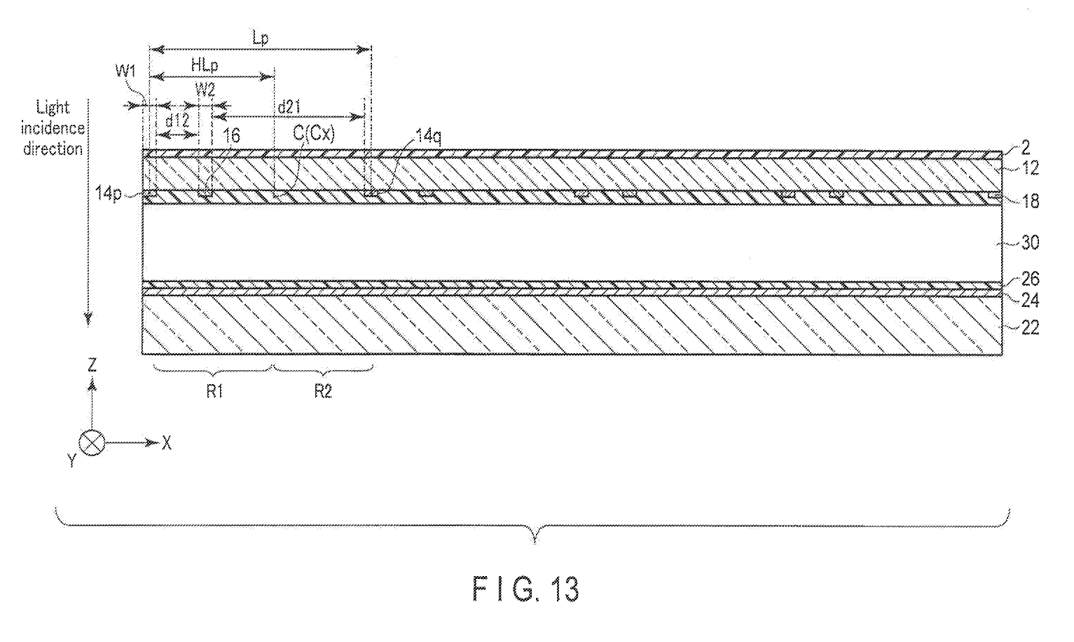

A modification to the second embodiment will be described below. FIG. 13 is a sectional view showing a configuration of a liquid crystal optical element according to the modification to the second embodiment. As shown in FIG. 13, in the liquid crystal optical element according to the modification, a second electrode 16 is shifted in the left direction from a central axis cx between first electrodes 14, or in a direction opposite to the direction of a pretilt of liquid crystal molecules. In other words, a first distance d12 is shorter than a second distance d21. In the modification of FIG. 13, the second electrode 16 is provided in a first region R1 and not in a second region R2. In the modification, it is desirable that the absolute value of a difference between the distances Δd (=|d21−d12|) should be adjusted so as to fall within 20% of electrode pitch Lp, preferably 10% thereof. The configuration except for the arrangement of the second electrode 16 is the same as that shown in FIG. 9; thus, its descriptions are omitted.

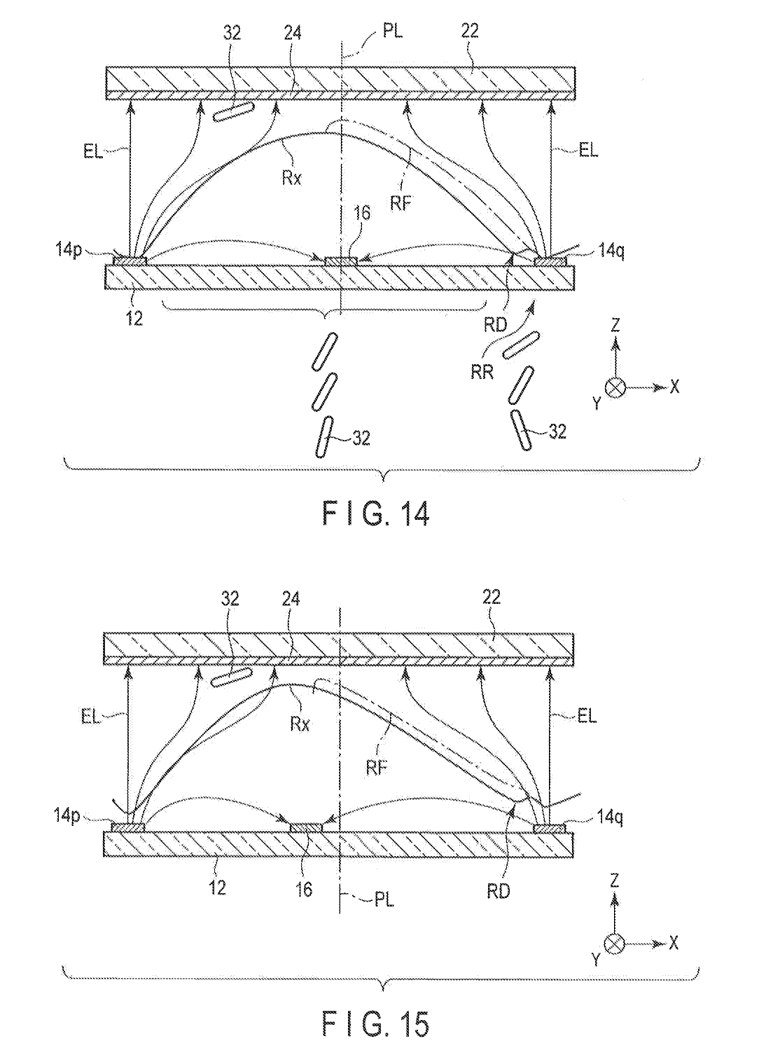

FIG. 14 is a diagram illustrating a profile of lines of electric force and that of refractive indices in the liquid crystal optical element shown as a reference example in FIG. 10, in which a voltage applied to the first electrode 14 is high. In the state of FIG. 14, the voltage applied to the first electrode 14 is higher than that in FIG. 10.

In the example of FIG. 14, a deformation of bend alignment appears near the first electrode 14 in the second region R2. In FIG. 14, the orientational state of liquid crystal molecules close to the first electrode 14 is schematically shown under the first electrode 14 provided in the second region R2. In the region between the first electrode 14q and the central axis cx alongside the second region R2, a step RD (minimum value) is present in the refractive index profile Rx.

The orientational deformation of nematic liquid crystal is divided into three modes: spray, twist and bend. In most liquid crystal material, the elastic coefficient corresponding to the bend alignment is the largest among all three, which means that the bend alignment is the most difficult to be deformed. In the region where the bend alignment occurs, electrical energy externally supplied is consumed mostly for the deformation and thus the range of the deformation is limited. Outside the region of the bend alignment (the region expanding to the left in FIG. 14), there is a region where the director of liquid crystal tilts along the pretilt (the orientational state of liquid crystal is schematically shown under the second electrode 16). In the boundary from the region of the bend alignment to the outside region, director of liquid crystal tilted in the opposite direction to the pretilt rises vertically and then tilts in the same direction as that in the outside region. In other words, from right to left in the boundary (in the −X-axis direction) in FIG. 14, the horizontal components of the liquid crystal director decrease and then increase again, with the result that a step RD (minimum value) is present in the refractive index profile Rx.

The refractive index profile with the step RD in the second region R2 behaves as a Fresnel lens in which the refractive index increases by the height of the step (such as a profile RF in FIG. 14). As a result, in the configuration of the reference example where the second electrode 16 is disposed at the midpoint between the first electrodes 14, when a high voltage is applied, the amount of reduction in refractive index is different between right and left sides of the central axis cx. In the liquid crystal optical element of the reference example, when a high voltage is applied, the peak position shifts to the right, and the refractive index profile (combination of the profile Rx and the profile RF) becomes asymmetrical.

FIG. 15 is a diagram illustrating a profile of lines of electric force and that of refractive indices in the liquid crystal optical element according to the modification. In the liquid crystal optical element according to the modification, the second electrode 16 is shifted in the −X-axis direction (left side) from the central axis cx between the first electrodes 14. In this configuration, the horizontal components of electrical field are reduced in a potion close to the first electrode 14q in the second region R2, and the incremental profile of the refractive index (denoted as RF) is suppressed. On the other hand, the horizontal electrical field is strong in a potion close to the first electrode 14p in the first region R1, and the decrease in the refractive index is suppressed. As a result, a difference in the profile of refractive index between the first and second regions R1 and R2 becomes small and accordingly the symmetry in the profile of the refractive index (combination of the profile Rx and the profile RF) is improved. Furthermore, in the modification, the amount of variation in refractive index (a difference between the maximum and minimum values of the refractive index profile Rx) is increased by applying a high voltage.

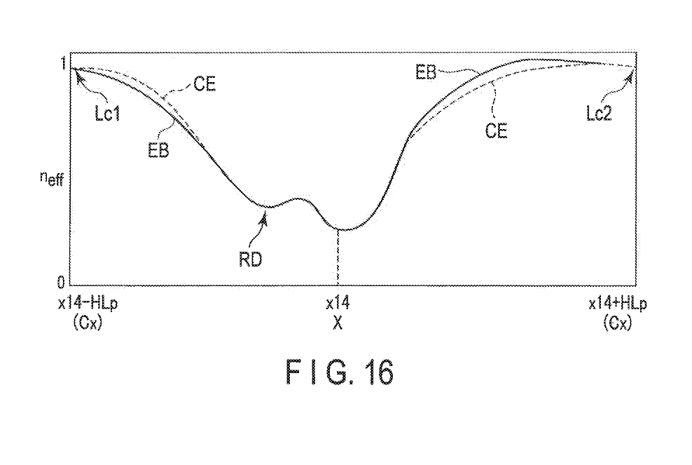

FIG. 16 is a graph showing characteristics of the liquid crystal optical element according to the modification. In FIG. 16, the solid line EB indicates a profile of refractive index in the liquid crystal optical element according to the modification in which the second electrode 16 is asymmetrical with respect to the central axis cx, and the broken line CE indicates a profile of refractive index in the liquid crystal optical element according to the reference example in which the second electrode 16 is symmetrical with respect to the central axis cx. Similar to FIG. 12, in FIG. 16, the horizontal axis represents a position in the X-axis direction and the vertical axis represents a refractive index neff.

In the profile CE of the reference example, a step RD (minimum value) is present in a region between the central position Lc1 of the left lens and the center of the first electrode 14. In the region between the central position Lc1 of the left lens and the center of the first electrode 14 the normalized refractive index neff is effectively higher than that in a region between the central position Lc2 of the right lens and the center of the first electrode 14 due to the incremental effect in the profile of refractive index.

In contrast, in the profile EB of the modification, the variations of refractive index neff are less than those in the reference example in a region between the central position Lc1 of the left lens and the center of the first electrode 14. On the other hand, the variations of refractive index neff are greater than those in the reference example in a region between the central position Lc1 of the right lens and the center of the first electrode 14. Accordingly, in the modification, the symmetry is improved in the profile of refractive index EB. As compared with the profile of refractive index EB shown in FIG. 12, the profile EB in FIG. 16 shows an increased difference between the maximum and minimum values of the refractive index profile Rx.

In the modification, the liquid crystal layer 30 also includes an orientation in which the director tilts up toward the second substrate 22 along the +X-axis direction from the first electrode 14p to the first electrode 14q. If the first distance d12 is made shorter than the second distance d21, the symmetry in the profile of refractive index Rx can be improved, as in the second embodiment, as well as a difference between the maximum and minimum values of the refractive index can be increased.

### Third Embodiment

A third embodiment will be described below. The third embodiment includes first and second application examples of the liquid crystal optical elements according to the foregoing embodiments. The liquid crystal optical elements of the application examples can be applied to various image devices including an image unit including pixels.

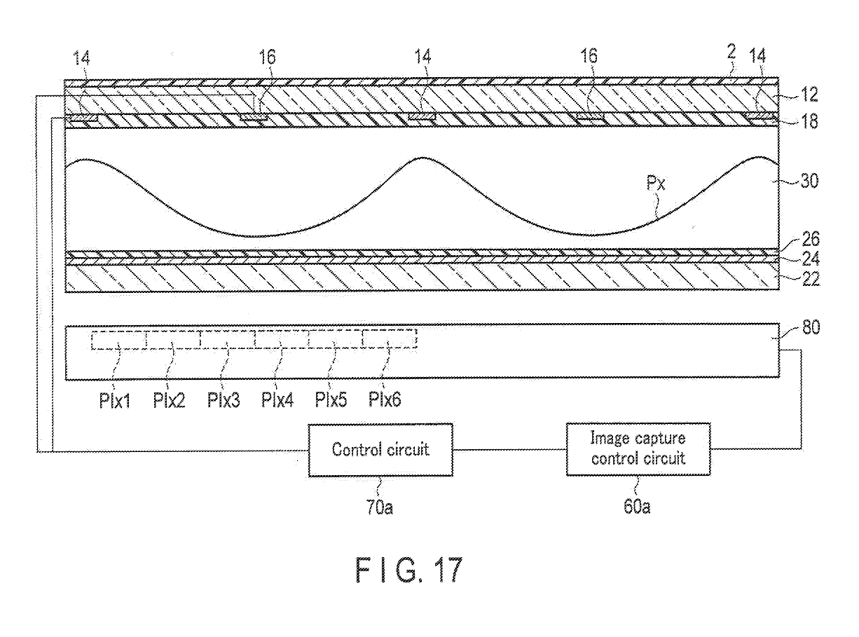

FIG. 17 is a schematic view showing a configuration of an imaging device as the first application example of a liquid crystal optical element. As shown in FIG. 17, the imaging device includes a liquid crystal optical element 1, an imaging unit (image unit) 80, an image control circuit 60a and a control circuit 70a including a driving unit which drives the liquid crystal optical element 1. The imaging device may include an imaging optical system (main lens unit) for making light from a subject (not shown) incident upon the liquid crystal optical element 1 and, in this case, the imaging optical system is disposed opposite to an image sensor of the imaging unit 80 with the liquid crystal optical element 1 between them.

In the first application example of FIG. 17, the liquid crystal optical element 1 is disposed on the light focusing side when it is brought into a lens state, or it is disposed such that the second substrate 22 is opposite to the light receiving surface of the imaging unit 80. The liquid crystal optical element 1 can also be disposed such that the first substrate 12 is opposite to the light receiving surface of the imaging unit 80. The liquid crystal optical element 1 has a configuration according to the first embodiment, the second embodiment or the modification to the second embodiment. FIG. 17 shows a single lens unit of the liquid crystal optical element 1; however, it is natural that the liquid crystal optical element 1 may include two lens units as shown in FIGS. 1-3.

The imaging unit 80 includes an image sensor and an imaging circuit to capture an image of a subject and generate an image signal corresponding to the subject. The image sensor has a light receiving surface for converting light from a subject, which is emitted from the liquid crystal optical element 1, into signal charges that are proportional to the amount of light. On the light receiving surface, a plurality of pixels (e.g., photodiodes as photoelectric conversion elements) are arranged in a two-dimensional array. The image sensor includes a plurality of pixel blocks. Each of the pixel blocks is a group of pixels arranged in, for example, the horizontal or vertical direction. In FIG. 17, for example, six pixels PIX1 to PIX6 constitute one pixel block. The array period of pixel blocks is made coincident with the lens pitch (arrangement period of the first electrodes 14) of, for example, the liquid crystal optical element 1. As described above, it is likely that a shift might occur between the period of the profile of refractive index and that of the electrode arrangement; thus, the period of pixel block and the lens pitch can be shifted from each other, taking the shift into account. Furthermore, a color filter can be provided to correspond to each of the pixels. The imaging circuit includes a driving circuit which drives each of the pixels of the image sensor and a pixel signal processing circuit which reads signal charges out of the pixels and processes them. The driving circuit controls the charges stored in the pixels of the image sensor and reads the signal charges out of the pixels as image signals such as voltage signals. The image signal processing circuit performs various processes, such as a process of controlling the gain of an image signal and a process of converting an image signal read as an analog signal into a digital signal.

The image control circuit 60a supplies the imaging unit 80 with, e.g., a timing pulse for controlling an operation of the imaging unit 80. The image control circuit 60a also captures an image signal obtained in the imaging unit 80 and performs various processes for the captured image signal. This signal processing includes a process of computing distance (depth) as well as signal processing necessary for displaying and recording images, such as white balance correction, tone correction, color correction and edge emphasis.

The control circuit 70a applies a voltage to the first electrodes 14, second electrode 16 and common electrodes 24 of the liquid crystal optical element 1 in synchronization with the control of the imaging unit 80 under the image control circuit 60a. As described above, the liquid crystal optical element 1 is so configured to vary the profile of refractive index in the liquid crystal layer 30 by the application of a voltage to the first electrodes 14, second electrode 16 and common electrodes 24. When no voltage is applied to the first electrodes 14, the refractive index of the liquid crystal layer 30 does not vary, therefore light incident upon the liquid crystal optical element 1 from a subject (not shown) passes through the liquid crystal optical element 1. At that time, a single high-resolution image is captured by the imaging device. When a voltage is applied to the first electrodes 14, the refractive index of the liquid crystal layer 30 varies and light incident upon the liquid crystal optical element 1 from a subject (not shown) is focused on the imaging unit 80 by the liquid crystal optical element 1. At that time, a plurality of images having a parallax are captured by the imaging device. A distance to the subject can be calculated using an amount of shift between images. Accordingly, the liquid crystal optical elements 1 according to the foregoing embodiments can be applied to the imaging device.

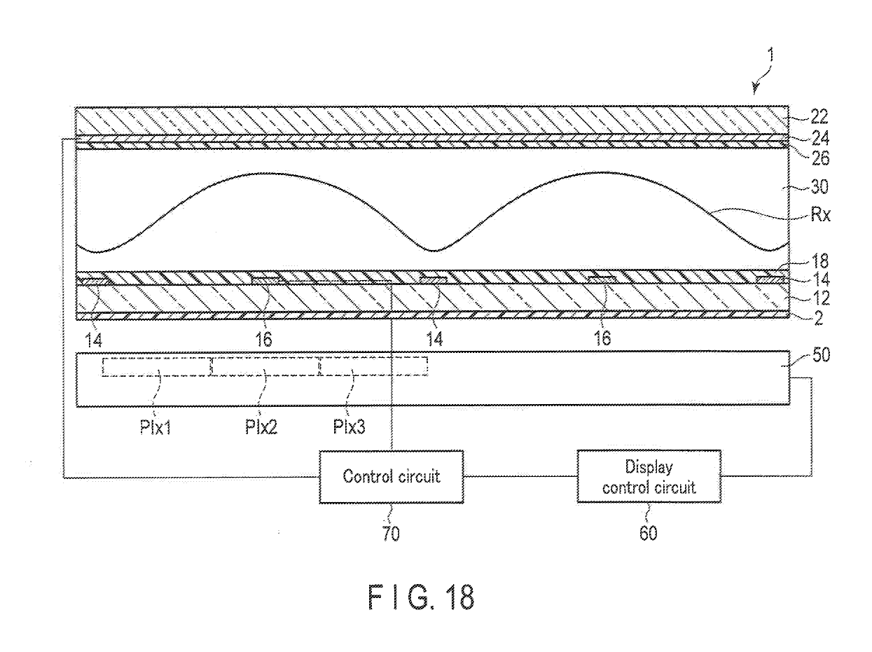

FIG. 18 is a schematic view showing a configuration of a display device as a second application example of the liquid crystal optical element. As shown in FIG. 18, the display device includes a liquid crystal optical element 1, a display unit (image unit) 50, a display control circuit 60 and a control circuit 70 including a driving unit that drives the liquid crystal optical element 1.

In the second application example shown in FIG. 18, the liquid crystal optical element 1 is disposed on the light focusing side when it is brought into a lens state, or it is disposed such that the second substrate 22 is opposite to the outside of the display device. The liquid crystal optical element 1 can also be disposed such that the first substrate 12 is opposite to the outside of the display device. The liquid crystal optical element 1 has a configuration according to the first embodiment, the second embodiment or the modification to the second embodiment. FIG. 18 shows a single lens unit of the liquid crystal optical element 1; however, it is natural that the liquid crystal optical element 1 may include two lens units as shown in FIGS. 1-3.

The display unit 50 is, for example, a liquid crystal display unit and an OLED display unit and includes a display surface for displaying an image and a driver. On the display surface, a plurality of pixels (which are formed by e.g., pixel electrodes, common electrodes and a liquid crystal layer interposed therebetween when the display unit is a liquid crystal display unit) are arranged in a two-dimensional array. The display surface includes a plurality of pixel blocks. Each of the pixel blocks is a group of pixels arranged in, for example, the horizontal direction. In FIG. 18, for example, three pixels PIX1 to PIX3 constitute one pixel block. The array period of pixel blocks is made coincident with the lens pitch (arrangement period of the first electrodes 14) of, for example, the liquid crystal optical element 1. As described above, it is likely that a shift might occur between the period of the refractive index profile and that of the electrode arrangement; thus, the pixel block period and the lens pitch can be shifted from each other, taking the shift into account. Furthermore, a color filter can be provided to correspond to each of the pixels. The driver drives a pixel electrode in response to a corresponding video signal input by the display control circuit 60. When the display unit is a liquid crystal display unit, the driver applies a voltage of grayscale level to the pixel electrodes in response to a corresponding video signal.

The display control circuit 60 supplies the driver with a video signal read from a recording medium or a video signal supplied from an external input terminal to control the operation of the display unit 50.

The control circuit 70 applies a voltage to the first electrodes 14, second electrode 16 and common electrodes 24 of the liquid crystal optical element 1 in synchronization with the control of the display unit 50 under the display control circuit 60. As described above, the liquid crystal optical element 1 is so configured to vary the profile of refractive index in the liquid crystal layer 30 by the application of a voltage to the first electrodes 14, second electrode 16 and common electrodes 24. When no voltage is applied to the first electrodes 14, the refractive index of the liquid crystal layer 30 does not vary and, at that time, the images displayed on the display unit 50 are incident upon an observer's eyes as they are. When a voltage is applied to the first electrodes 14, the refractive index of the liquid crystal layer 30 varies and, at that time, the images displayed on the display unit 50 are incident upon the observer's eyes as a plurality of parallax images. For example, an image of pixel PIX1 is incident upon the right eye of an observer, an image of pixel PIX2 is incident upon the left eye thereof, and an image of pixel PIX3 is incident upon the right eye thereof. Images that differ in parallax are incident upon the right and left eyes of an observer and thus a stereoscopic view can be provided to the observer. Thus, the liquid crystal optical elements 1 according to the foregoing embodiments can be applied to various image devices including pixels, such as an imaging device and a display device.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

The following is a summary of the present invention.

[1]A liquid crystal optical element comprising:

a first substrate including a first main surface;

a second substrate including a second main surface opposed to the first main surface;

a plurality of first electrodes provided on part of the first main surface;

common electrodes which are provided on the second main surface and some of which are opposed to the first electrodes;

a liquid crystal layer formed between the first main surface and the second main surface;

a first alignment layer formed between the first substrate and the liquid crystal layer to align liquid crystal molecules of the liquid crystal layer horizontally; and

a second alignment layer formed between the second substrate and the liquid crystal layer to align liquid crystal molecules of the liquid crystal layer horizontally,

wherein the first alignment layer has anchoring force that is weaker than that of the second alignment layer.

[2] The liquid crystal optical element according to [1], wherein the first alignment layer is a photo-aligned layer formed by photo-alignment process.

[3] The liquid crystal optical element according to [1] or [2], wherein the second alignment layer is a aligned layer formed by rubbing process.

[4] The liquid crystal optical element according to any one of [1] to [3], wherein the pretilt angle for the first alignment layer is almost 0°.

[5] The liquid crystal optical element according to any one of [1] to [4], wherein the first alignment layer is formed by polyimide having a photosensitive group such as a 4-chalconyl group, a 4′-chalconyl group, a coumarin group and a cinnamoyl group.

[6] The liquid crystal optical element according to any one of [1] to [5], further comprising a second electrode provided between adjacent ones of the first electrodes.

[7] The liquid crystal optical element according to [6], wherein a first distance between one of closest two of the first electrodes and the second electrode between the closest two of the electrodes and in a direction orthogonal to an extending direction of the first electrodes differs from a second distance between the other of the closest two of the first electrodes and the second electrode and in a direction orthogonal to an extending direction of the first electrodes.

[8] The liquid crystal optical element according to [7], wherein the liquid crystal layer includes a liquid crystal orientation in which a director tilts up toward the second substrate along a direction from the one of the closest two of the first electrodes toward the other thereof, and

the first distance is longer than the second distance.

[9] The liquid crystal optical element according to [7], wherein the liquid crystal layer includes a liquid crystal orientation in which a director tilts up toward the second substrate along a direction from the one of the closest two of the first electrodes toward the other thereof, and

the first distance is shorter than the second distance.

[10] The liquid crystal optical element according to [8], wherein the first distance is not greater than 1.2 times as long as the second distance.

[11] The liquid crystal optical element according to [9], wherein the second distance is not greater than 1.2 times as long as the second distance.

[12] An image device comprising:

the liquid crystal optical element according to any one of [1] to [11];

an image unit on which the liquid crystal optical element is disposed and which includes pixels; and

a driving unit which drives the liquid crystal optical element.

[13] The liquid crystal optical element according to [6], wherein the second electrode is provided in one of regions divided by a central axis parallel to an extending direction of the first electrodes, and the central axis passes through a midpoint of a segment connecting a center of one of closest two of the first electrodes and a center of the other of the closest two of the first electrodes.

[14] The liquid crystal optical element according to any one of [6] to [13], wherein the liquid crystal layer has one of positive dielectric anisotropy or negative dielectric anisotropy.

[15] The liquid crystal optical element according to any one of [6] to [14], wherein the liquid crystal molecules of the liquid crystal layer are aligned horizontally when no voltage is applied between the first electrodes, the common electrodes, and the second electrode.

[16] The liquid crystal optical element according to [15], wherein the liquid crystal molecules aligned horizontally have a pretilt angle of not less than 0° and not greater than 30°.

[17] An image device comprising:

the liquid crystal optical element according to any one of [6] to [16];

an image unit on which the liquid crystal optical element is arranged and which includes pixels;

a control circuit which applies a voltage to the first electrodes, the second electrode and the common electrodes,

wherein the control circuit applies a voltage to the first electrodes, the second electrode and the common electrodes such that a profile of refractive index in the liquid crystal layer almost monotonously increases along a direction from one of closest two of the first electrodes toward the second electrode and along a direction from the other of the closest two of the first electrodes toward the second electrode.

[18] The image device according to [17], wherein the control circuit applies a voltage to the first electrodes, the second electrode and the common electrodes such that a minimum value is formed either in a profile of refractive index in the liquid crystal layer between one of the closest two of the first electrodes and the second electrode or in a profile of refractive index in the liquid crystal layer between the other of the closest two of the first electrodes and the second electrode.

[19] The image device according to [18], wherein the liquid crystal layer includes a liquid crystal orientation in which a director tilts up toward the second substrate along a direction from the one of the closest two of the first electrodes toward the other thereof, and

the control circuit forms the minimum value of the profiles of the refractive index in the region between the other of the closest two first electrodes and the second electrode.

[20] The image device according to any one of [17] to [19], wherein the image unit is a display unit which displays an image, and

the liquid crystal optical element selects one of a state in which a light ray from the image unit is transmitted and a state in which the light ray from the image unit is focused.

[21] The image device according to any one of [17] to [19], wherein the image unit is an imaging unit which captures an image of a subject, and

the liquid crystal optical element selects one of a state in which light is emitted from the subject to the imaging unit as it is and a state in which light is focused from the subject and emitted to the imaging unit.

What is claimed is:

1. A liquid crystal optical element comprising:
a first substrate including a first main surface;
a second substrate including a second main surface opposed to the first main surface;
a plurality of first electrodes provided on part of the first main surface;
common electrodes which are provided on the second main surface and some of which are opposed to the first electrodes;
a liquid crystal layer formed between the first main surface and the second main surface;
a first alignment layer formed between the first substrate and the liquid crystal layer to align liquid crystal molecules of the liquid crystal layer horizontally; and
a second alignment layer formed between the second substrate and the liquid crystal layer to align liquid crystal molecules of the liquid crystal layer horizontally,
wherein the first alignment layer has an anchoring force that is weaker than an anchoring force of the second alignment layer.

2. The liquid crystal optical element according to claim 1, wherein the first alignment layer is a photo-aligned layer formed by photo-alignment process.

3. The liquid crystal optical element according to claim 1, wherein the second alignment layer is an aligned layer formed by rubbing process.

4. The liquid crystal optical element according to claim 1, wherein a pretilt angle for the first alignment layer is 0°.

5. The liquid crystal optical element according to claim 1, wherein the first alignment layer is formed by polyimide having a photosensitive group such as a 4-chalconyl group, a 4′-chalconyl group, a coumarin group and a cinnamoyl group.

6. The liquid crystal optical element according to claim 1, further comprising a second electrode provided between adjacent ones of the first electrodes.

7. The liquid crystal optical element according to claim 6, wherein a first distance between one of closest two of the first electrodes and the second electrode between the closest two of the electrodes and in a direction orthogonal to an extending direction of the first electrodes differs from a second distance between other of the closest two of the first electrodes and the second electrode and in a direction orthogonal to an extending direction of the first electrodes.

8. The liquid crystal optical element according to claim 7, wherein the liquid crystal layer includes a liquid crystal orientation in which a director tilts up toward the second substrate along a direction from the one of the closest two of the first electrodes toward the other thereof, and
the first distance is longer than the second distance.

9. The liquid crystal optical element according to 7, wherein the liquid crystal layer includes a liquid crystal orientation in which a director tilts up toward the second substrate along a direction from the one of the closest two of the first electrodes toward the other thereof, and
the first distance is shorter than the second distance.

10. The liquid crystal optical element according to claim 8, wherein the first distance is not greater than 1.2 times as long as the second distance.

11. The liquid crystal optical element according to claim 9, wherein the second distance is not greater than 1.2 times as long as the second distance.

12. An image device comprising:
the liquid crystal optical element according to claim 1;
an image unit on which the liquid crystal optical element is disposed and which includes pixels; and
a driving unit which drives the liquid crystal optical element.
